(19) United States
(12) Patent Application Publication
(10) Pub. No.: US 2023/0351849 A1
(43) Pub. Date: Nov. 2, 2023

(54) SYSTEMS AND METHODS FOR DISTRIBUTING RETAIL-FUNDED JACKPOTS USING GEOLOCATION DATA

(71) Applicant: Gamesys Ltd., London (GB)

(72) Inventor: Robeson Mandela Reeves, London (GB)

(21) Appl. No.: 17/733,195

(22) Filed: Apr. 29, 2022

(51) Int. Cl. G07F 17/32

(52) U.S. Cl. CPC G07F 17/3258

(57) ABSTRACT

Systems and methods for facilitating retail-funded jackpots that are increased based on qualifying retail transactions rather than wagers, and which can be won while users of a mobile wagering app are completing purchases at participating retailers, are described. In accordance with some embodiments, users of a mobile wagering app may utilize NFC-enabled jackpot terminals placed at participating retailers to cause a contribution to a jackpot to be made (e.g., funded by a provider of the mobile wagering app and based on a purchase total or other transaction data) and to trigger a jackpot awarding event. In some embodiments, once a given mobile wagering app user is identified as a primary jackpot winner, other users of the mobile wagering app who are within a predetermined proximity to the primary jackpot winner also win a portion of the jackpot.

### BACKGROUND

Mobile wagering apps (e.g., sports betting mobile apps) are continuously gaining in popularity and acceptance, creating a crowded and confusing list of such mobile wagering apps for players to choose from. There is an increasing need to differentiate mobile wagering apps from one another and create competitive advantages that provide unique benefits to users. For a mobile wagering app provider that also has access to dedicated hardware/terminal capabilities or can partner with an entity to access such capabilities, there is a unique opportunity to leverage such terminals to differentiate its mobile wagering app while providing new benefits to its users and generating additional revenue streams that are independent of wagering activities.

### SUMMARY OF EXAMPLE EMBODIMENTS

Applicant has recognized that a provider of a mobile wagering app can attract more persons to download and register as subscribers, members or users (collectively “users”) of its mobile wagering app by providing to such users additional opportunities for winning prizes (such as a jackpots that continue to increase until won) without having to place additional bets. Such a feature would provide excitement and a potential for financial upside that is distinct to the primary functionality of such an app (facilitating wagering). Applicant has invented a unique system in which users of such a mobile wagering app can win jackpots or other prizes while participating in retail transactions at Brick 'N Mortar retailers. In accordance with some embodiments, a jackpot value is built up over time by having a provider of the mobile wagering app (and/or another entity, such as the participating retailer) make a contribution to, or cause an increase to, the jackpot value upon an occurrence of a qualifying retail transaction event. One example of a qualifying retail transaction event is a user who has the mobile wagering app installed on his/her mobile device providing an indication of being a registered user of the app while participating in a retail transaction at a participating retailer (e.g., tapping an NFC-enabled mobile device to a dedicated jackpot terminal associated with a point-of-sale (POS) at a participating retailer during a check-out process at that retailer).

In accordance with some embodiments, participating retailers are equipped with dedicated jackpot terminals operable to recognize an input from a user of a corresponding mobile wagering app. For example, such jackpot terminals may be NFC-enabled and thus exchange data from a mobile device of a user upon the user tapping his/her it to the terminal when participating in a retail transaction (e.g., a purchase of a product or service) at the participating retailer. In other embodiments, jackpot terminals located at participating retailers may be operable to receive data upon the user scanning a QR code displayed on the jackpot terminal, the user providing a mobile telephone number associated with the user, etc. In some embodiments, such dedicated jackpot terminals are further operable to communicate with a POS of the relevant retailer in order to receive, obtain and/or confirm transaction data (e.g., that the user is actually purchasing a product or service and didn't just tap his/her phone to the jackpot terminal; a transaction value or purchase total for the transaction, etc.). In accordance with some embodiments, a dedicated jackpot terminal may be equipped with one or more of NFC, BLUETOOTH, Wi-Fi or other communication technology that may allow it to communicate with a user and/or user mobile device and/or automatically identify other users of the mobile wagering app who are within proximity to the jackpot terminal at a particular time (e.g., within a predetermined period of time from a primary jackpot winner being determined).

In accordance with one embodiment, on various occasions (e.g., periodically, during specified jackpot distribution events, or randomly) a determination of whether at least a portion of a jackpot value is to be awarded to a particular user is triggered. Such occasions are referred to herein as jackpot awarding events. The particular user on behalf of whom (or for the primary benefit of whom) a jackpot awarding event is triggered, in the case of the user being determined a winner as a result of the jackpot awarding event, is referred to as the primary jackpot winner herein. A jackpot awarding event may comprise applying a random number algorithm similar to a random number generator (RNG)-driven process utilized in various jackpot determining schemes in wagering game contexts; the embodiments described herein are not dependent on any particular method or scheme for determining whether a particular user is to be awarded at least a portion of the jackpot value as a result of a jackpot awarding event.

In some embodiments, each qualifying retail transaction event is also a jackpot awarding event (i.e., during each qualifying retail transaction event, in addition to a contribution to the jackpot value being triggered, a determination of whether the user participating in that qualifying retail transaction event is to be awarded at least a portion of the then-current jackpot value is also triggered). In some embodiments, only a sub-set of qualifying retail transaction events are also jackpot awarding events (e.g., a jackpot awarding event is triggered only if the jackpot value is at least a predetermined minimum value). In yet other embodiments, jackpot awarding events are different from qualifying transaction events.

In accordance with some embodiments, if a jackpot awarding event results in a determination that at least a portion of the jackpot value is to be awarded to the primary jackpot winner, another portion (e.g., a smaller portion) of the jackpot value is also awarded to additional users. Such additional users are referred to as secondary jackpot winners herein. A determination or identification of secondary jackpot winners may be done contemporaneously or within a predetermined window of time from the primary jackpot winner being determined.

In accordance with some embodiments, such secondary jackpot winners comprise users (subscribers, members or registered users of the mobile wagering app) that are within a proximity to the primary jackpot winner, the primary jackpot winner's mobile device and/or the jackpot terminal at which the primary jackpot winner participated in a transaction that triggered a jackpot awarding event. In some embodiments, such predetermined proximity may be determined based on geolocation or other location data from the respective users' mobile devices. In some embodiments, such secondary jackpot winners comprise users who are within a predetermined proximity to the primary jackpot winner or relevant jackpot terminal within a predetermined period of time from a result of the jackpot awarding event being determined (e.g., X minutes). For example, a countdown timer may be triggered once the primary jackpot winner is determined to be an awardee of a first portion of the jackpot value as a result of a jackpot awarding event, and one or more secondary jackpot winners who are determined to be within Y feet of the primary jackpot winner (or the relevant jackpot terminal) at the conclusion of X minutes from the initiation of the countdown timer are awarded a second portion of the jackpot value. In accordance with some embodiments, the second portion may comprise a remainder of the jackpot value once the first portion is deducted from the total jackpot value at the time.

In one embodiment, the second portion of the jackpot is awarded evenly among the one or more secondary jackpot winners. Other methodologies, algorithms and schemes may be utilized to determine how much of the second portion of the jackpot each secondary jackpot winner is to receive; the embodiments described herein are not dependent on any particular such scheme. In some embodiments, secondary jackpot winners may receive other prizes distinct from the jackpot rather than a second portion of the jackpot and the entire jackpot may be awarded to the primary jackpot winner. For example, in some embodiments the system may maintain an inventory of secondary prizes to award to secondary jackpot winners, which may be monetary or non-monetary (e.g., coupons, gift cards or credit towards purchases at one or more retailers, physical products or vouchers for services, etc.).

Applicant has recognized several benefits to the systems and methods described herein. Examples of such benefits include, without limitation: (i) distinguishing the relevant mobile wagering app from others that offer similar primary wagering services, by providing users with additional monetary winning opportunities and excitement aside from the wagering functionality of the app; (ii) an ability to encourage users of the mobile wagering app to congregate or visit particular locations in order to be eligible to win portions of the jackpot as described herein (either as primary jackpot winners or secondary jackpot winners); and (iii) additional potential revenue streams (e.g., participating retailers may pay to be part of the systems and methods described herein, in order to encourage users to make purchases at these retailers so as to trigger qualifying retail transaction events and/or jackpot awarding events).

Certain aspects, advantages, and novel features of various embodiments of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

Although several embodiments, examples and illustrations are disclosed below, it will be understood by those of ordinary skill in the art that the invention described herein extends beyond the specifically disclosed embodiments, examples and illustrations and includes other uses of the invention and obvious modifications and equivalents thereof. Embodiments of the invention are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the invention. In addition, embodiments of the invention can comprise several novel features and it is possible that no single feature is solely responsible for its desirable attributes or is essential to practicing the inventions herein described.

With the above-described advantages and features of the disclosure that will become hereafter apparent, the disclosure may be more clearly understood by reference to the drawings attached herein and their embodiments.

### BRIEF DESCRIPTION OF THE FIGURES

FIG. 1 is a block diagram of an overview of one example system consistent with at least some embodiments described herein.

FIG. 2 is a block diagram of an example user mobile device consistent with at least some embodiments described herein.

FIGS. 3A and 3B are diagrams illustrating mobile or portable electronic screen displays that may be output to users of respective mobile devices, in accordance with at least some embodiments described herein.

FIG. 4 is a block diagram of an example wagering app server consistent with at least some embodiments described herein.

FIG. 5 is a block diagram of an example jackpot management server consistent with at least some embodiments described herein.

FIG. 6 is a flowchart of an example process consistent with at least some embodiments described herein.

### DETAILED DESCRIPTION

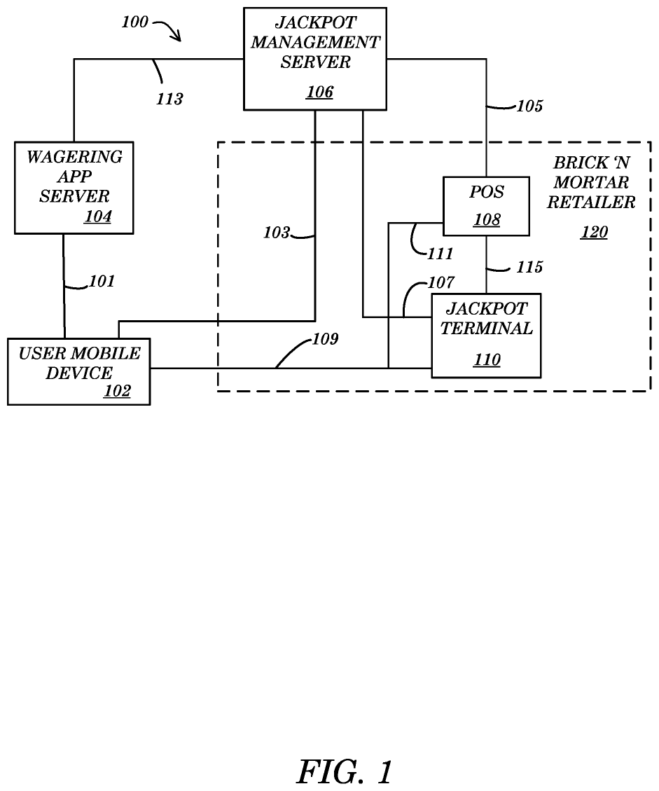

Referring now to FIG. 1, illustrated therein is a block diagram of one example system 100 which may be useful in facilitating some embodiments described herein. The system 100 comprises a user mobile device 102, a wagering app server 104, a jackpot management server 106, a Point-of-Sale (POS) terminal 108, and a jackpot terminal 110 (the last two of which are indicated as being located in, or associated with, a “Brick 'N Mortar Retailer 120 (the term “Brick 'N Mortar” being intended to refer to a retailer with a physical location which users may visit to purchase goods or service, including restaurants, stores and entertainment venues such as casinos and the retail shops that may be associated with such casinos, and is at times referred to in a shorthand manner as “retailer” herein). The various devices of system 100 may be operable to communicate with at least one other device of system 100 via a network. The network may comprise, for example, the Internet, a wide area network, a cellular data network or another network or a combination of such networks. Additionally, in some embodiments one or more of the devices may be located behind a firewall. It should be understood that although not shown in FIG. 1, other networks and devices may be in communication with any of the devices of system 100. For example, a user mobile device 102 may be in communication with a mobile network (not shown) such as a Wi-Fi or cellular telephone network that accommodates wireless communication with mobile devices as is generally known to those skilled in the art.

Although only one user mobile device 102 is illustrated, it should be understood that any number of mobile devices 102 may participate in the system 100. Similarly, although only a single Brick 'N Mortar Retailer 120 is illustrated, any number of such retailers (each with a respective POS terminal 108 and jackpot terminal 110) may participate in the processes and embodiments described herein. Thus, the references to a user mobile device 102, POS terminal 109 and jackpot terminal 110 herein are references to example ones of such devices that may facilitate embodiments described herein, and the functionality each may comprise or support.

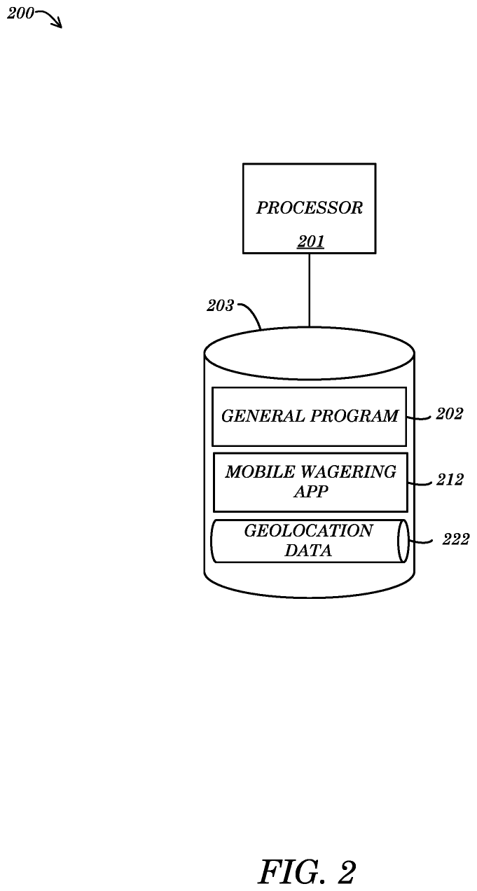

The user mobile device 102 may comprise, for example, a computing device operable to communicate with (e.g., transmit data to or receive data from) one or more of the devices of system 100 and have the mobile wagering app facilitated by wagering app server 104 installed thereon, which wagering app may facilitate the user's interactions with the wagering app server 104 and/or the jackpot terminal 110. In some embodiments, the user mobile device 102 may comprise a smartphone, tablet computing device, laptop or other portable computing device. It should be understood that although only one user mobile device 102 is illustrated, the system 100 may be operable to support any number and various types of user mobile devices 102. A more detailed description of one embodiment of a user mobile device 102 is provided herein with reference to FIG. 2.

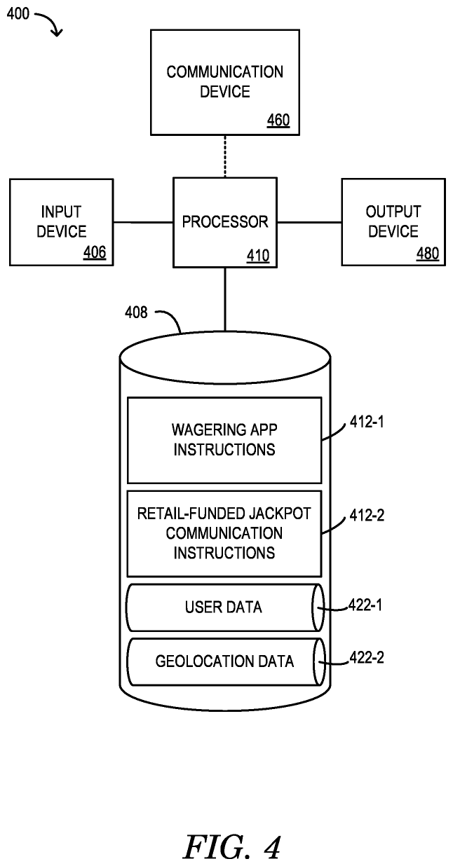

The wagering app server 104 may comprise one or more computing devices, working in parallel or series if more than one, operable to facilitate the play of online wagering games (e.g., sports betting) and/or earning of benefits or rewards (for gaming or non-gaming activities) supported by the provider of the mobile wagering app. In accordance with some embodiments, the wagering app server 104 may comprise an online server operated on or behalf of a provider of the mobile wagering app via which users can win jackpots funded by retail transactions (i.e., transactions of conventional purchases that are not wagering or betting), as described herein (such jackpots also being referred to at times as retail-funded jackpots herein). In accordance with some embodiments, the wagering app server 104 may perform functions or subroutines for managing a user's participation in the wagering app (e.g., managing the user's account, including wagers made by the user, funds available to the user, progress of the user's wagers made via the app, etc.), in addition to facilitating the retail-funded jackpot functionality described herein (wherein jackpots are funded based on retail transaction events and awarded without requiring wagers to be placed in association therewith). A more detailed description of one embodiment of a wagering app server 104 is provided herein with reference to FIG. 4.

A jackpot management server 106 may comprise, for example, one or more computing devices, working in parallel or series if more than one, operated by or on behalf of a provider of the mobile wagering app via which users of the app may win retail-funded jackpots by participating in retail transaction events at Brick 'N Mortar Retailer 120 (sometimes referred to, for purposes of brevity, simply as an “mobile wagering app” or “wagering app” herein). The jackpot management server 106 may be operable to manage each such retail-funded jackpot and the distribution thereof. In some embodiments, a jackpot terminal 110 may be a dedicated hardware terminal for facilitating retail-funded jackpots as described herein, and operated by or on behalf of a provider of a mobile wagering app that provides such a retail-funded jackpot feature. In other embodiments, a jackpot terminal 110, while supporting the retail-funded jackpot functionality, may also be operable to provide or support other functionality (e.g., other transaction-related benefits or functions at a retailer, or as a module of a POS system).

In some embodiments, the jackpot management server 106 may be operable to receive data from a jackpot terminal 110, which jackpot terminal 110 may in turn be operable to receive data from a POS 108 of the Brick 'N Mortar Retailer 120. For example, transaction data obtained or received from POS 108 (e.g., via a jackpot terminal 110) may be utilized by the jackpot management server 106 to determine whether a qualifying retail transaction event has occurred and thus whether an increase or contribution to a jackpot value should be made. As described herein, in some embodiments increases or contributions to a jackpot value may be triggered by an occurrence and detection of a qualifying retail transaction events and/or based on the transaction total or purchase amount of such qualifying retail transaction events. For example, a contribution based on a percentage of the transaction total (e.g., 2%) may be processed by the jackpot management server 106 for each qualifying retail transaction event. In other embodiments, an increase or contribution to a retail-funded jackpot, while triggered by a qualifying retail transaction event, may be an amount that is not dependent on transaction data (e.g., the jackpot management server may be programmed to increase a jackpot value by a predetermined amount, an amount selected randomly from a set of possible contribution amounts, etc. Irrespective of how the magnitude or value of a jackpot contribution amount is determined, a function of the jackpot management server 106 may be to increase the jackpot value of a given jackpot in response to each qualifying retail transaction event recognized by the jackpot management server.

It should be noted that in some embodiments the jackpot management server 106 may manage multiple jackpots at a time (e.g., regional jackpots, jackpots for different classes or categories of users, jackpots pertaining to current ongoing special promotions, jackpots corresponding to different types or categories of qualifying retail transaction events, etc.). In such embodiments, the functionality of the jackpot management server 106 may include determining which jackpot should be increased responsive to recognizing a qualifying retail transaction event.

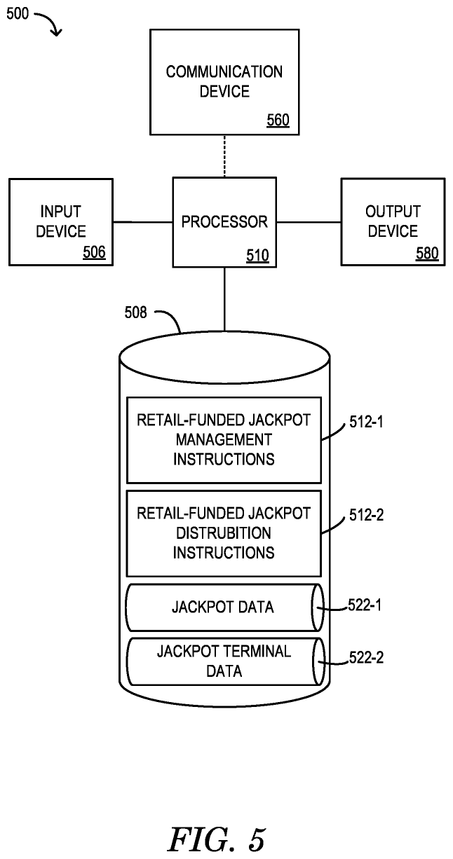

In some embodiments, the jackpot management server 106 may store a subroutine or module for determining when a retail-funded jackpot (or portion thereof) is to be awarded to a user. It should be noted that whenever the term “jackpot” is used herein, such references may equally apply to a portion of a jackpot unless explicitly stated otherwise; accordingly, the term “jackpot” may be used as a shorthand for “jackpot (or portion thereof).” A more detailed description of one embodiment of a jackpot management server 106 is provided herein with reference to FIG. 5.

The jackpot management server 106 may be operable to communicate with a wagering app server 104 in order to facilitate the management of one or more jackpots and/or distribution thereof, in accordance with some embodiments described herein. For example, in some embodiments, rather than awarding a jackpot to a user or user account directly, the jackpot management server 106 may work with the wagering app server 104 to award a jackpot (e.g., by communicating to the wagering app server 104 a particular jackpot value to be awarded to a particular user of the wagering app, such that the wagering app server 104 appropriately credits an account of that user as stored and managed by the wagering app server 104).

In some embodiments, some the functionalities, subroutines or processes described herein as being performed by the jackpot management server 106 may be carried out by the wagering app server 104, and vice versa. In some embodiments, the jackpot management server 106 and the wagering app server 104 may comprise the same device or set of devices (i.e., in some embodiments the jackpot management server 106 may comprise the wagering app server 104).

A POS 108 may comprise a point-of-sale (POS) terminal comprising hardware and/or software for processing payments, such as credit card or cash payments, at a physical retail location. A POS 108 may include a credit card processing component or module, for communicating with a credit card network. In accordance with some embodiments, the POS 108 may be operable to communicate with a jackpot terminal 110, via wired or wireless communication. For example, the POS 108 may be operable to transmit an indication of a purchase or transaction total to the associated jackpot terminal 110, in response to a request from the jackpot terminal 110 or other event. In some embodiments, the POS 108 may comprise a conventional hardware terminal such as the IBM 4694 Point of Sale (POS) Terminal or the STATION DUO by CLOVER BUSINESS SOLUTIONS. In some embodiments, the POS 108 may comprise a mobile POS station such as the SQUARE POINT OF SALE, with or without the SQUARE REGISTER.

A jackpot terminal 110 may comprise a dedicated hardware terminal operated by or on behalf of a provider of a wagering app supported by the wagering app server 104. In accordance with some embodiments, a jackpot terminal 110 may be operable to communicate with mobile user devices 102 and/or receive a signal, data or indication from a user mobile device 102 that has the mobile wagering app downloaded thereon (e.g., data that it recognizes as triggering a qualifying retail transaction event). The jackpot terminal 110 may utilize one or more of the following non-limiting technologies to communicate with a user mobile device 102 (e.g., to obtain data from, or send a signal to, a given user mobile device 102 and/or the mobile wagering app installed thereon): (i) NFC functionality (e.g., to read data from a user mobile device in response to a user tapping a mobile device 102 to the jackpot terminal 110); (ii) BLUETOOTH functionality (e.g., to read data from a user mobile device and/or transmitting data to a user mobile device that is within proximity to the jackpot terminal 110); (iii) QR codes (e.g., a user can scan a QR code using the mobile wagering app in order to indicate that he/she is participating in a retail transaction at the relevant retailer 120); and (iv) entering a mobile device telephone number into the jackpot terminal 110 (to indicate that the user is participating in a retail transaction at the relevant retailer).

In some embodiments, the jackpot terminal 110 may communicate with a POS 108 to obtain transaction data (e.g., a purchase total for a transaction, in embodiments in which a contribution to a jackpot value is based on a purchase total of the transaction that comprises the qualifying retail transaction event that is causing the jackpot value to be increased). In other embodiments, the jackpot terminal 110 may be a stand-alone terminal that is dedicated to supporting the management of the retail-funded jackpots described herein by facilitating communications between a user mobile device 102 and a jackpot management server 106 but without communicating directly with a POS 108. In some embodiments, the jackpot terminal 110 may not be a separate terminal but may instead comprise a software module stored in POS 108, which causes POS 108 to perform at least some of the functions described herein as being performed by a jackpot terminal 110. In other words, in some embodiments a POS terminal 108 and a jackpot terminal 110 may comprise a single device.

As described herein and illustrated in FIG. 1, a jackpot management server 106 may be operable to receive and/or transmit data to a user mobile device 102 (e.g., via communication pathway 103), the wagering app server 104 (via a communication pathway 113), a POS 108 (via a communication pathway 105) and/or a jackpot terminal 110 (via a communication pathway 107). As also described herein and illustrated in FIG. 1, a jackpot management server 106 may be operable to transmit or output data or information to a user mobile device 102 (e.g., via communication pathway 103), the wagering app server 104 (via a communication pathway 113), a POS 108 (via a communication pathway 105) and/or a jackpot terminal 110 (via a communication pathway 107). In some embodiments, the jackpot management server 106 may be operable to transmit data or otherwise communicate with another device not illustrated in FIG. 1, to facilitate the management and/or distribution of a jackpot (e.g., with a server which maintains player financial accounts, to a stored value card of a player, etc.).

A user mobile device 102 may also be operable to communicate with a jackpot management server 106 of a Brick 'N Mortar Retailer 120 via a communication path 103. For example, the user mobile device 102 may be operable to transmit data associated with a retail transaction event to the jackpot management server 106 (e.g., transaction amount, a location of the transaction, etc.) or receive data directly from the jackpot management server 106 (e.g., a notification that the user of the user mobile device is a primary jackpot winner or a secondary jackpot winner).

It should be understood that each of the devices 102, 104, 106, 108 and 110 may communicate directly or indirectly, via a wired or wireless medium such as the Internet, LAN, WAN or Ethernet, Token Ring, or via any appropriate communications means or combination of communications means. For example, in one embodiment communication among any and all of the devices of system 100A may occur over the Internet through a Web site maintained by computer on a remote server or over an on-line data network including commercial on-line service providers, bulletin board systems and the like. In yet other embodiments, communication among any of the devices of system 100 may occur over RF, cable TV, satellite links and the like. Any of the foregoing may comprise any of the respective pathways 101 through 113 illustrated in FIG. 1.

The system 100 may be operable to facilitate communication among the devices 102, 104, 106, 108 and 110 using known communication protocols. Possible communication protocols that may be part of the system 100A include, but are not limited to: Ethernet (or IEEE 802.3), ATP, RFID, NFC, BLUETOOTH, HTTP, HTTPS and Transmission Control Protocol/Internet Protocol (TCP/IP). Communication may be encrypted to ensure privacy and prevent fraud in any of a variety of ways well known in the art, some of which are described herein. Any of the foregoing communication protocols (or other known communication protocols) may be used to facilitate communication along the communication pathways 101 through 113. It should be noted that not all of the communication pathways 101 through 113 are necessary or preferred. For example, as described elsewhere herein, in some embodiments the POS 108 and jackpot terminal 110 may not communicate directly, in which case communication pathway 115 may not be part of the system 100. In another example, the jackpot management server 106 may not communicate with POS 108 directly, in which case communication pathway 115 may not be part of system 100.

Turning now to FIG. 2, illustrated therein is a block diagram of an example user mobile device 200, which may be one embodiment of a user mobile device 102 of FIG. 1. The user mobile device 200 may be implemented as a system controller, a dedicated hardware circuit, an appropriately programmed general-purpose computer, a smartphone, a tablet computer or any other equivalent electronic, mechanical or electro-mechanical device. The user mobile device 200, as well as other devices described herein (such as a wagering app server 104, jackpot management server 106 and/or POS 108), as well as components thereof, may be implemented in terms of hardware, software or a combination of hardware and software.

The user mobile device 200 comprises a processor 201, such as one or more of APPLE A-series BIONIC processors manufactured by APPLE or the EXYNOS processor by SAMSUNG. The processor 201 may be in communication with a communication port (not shown) for communicating with one or more other devices and a memory 203. The memory 203 may comprise an appropriate combination of magnetic, optical and/or semiconductor memory, and may include, for example, Random Access Memory (RAM), Read-Only Memory (ROM), a compact disc and/or a hard disk. The processor 201 and the memory 203 may each be, for example: (i) located entirely within a single computer or other device; or (ii) connected to each other by a remote communication medium, such as a serial port cable, telephone line or radio frequency transceiver. In one embodiment, the user mobile device 200 may be operable to communicate with a remote server computer which maintains one or more databases (e.g., a wagering app server 104).

The memory 203 stores a program 202 for controlling the processor 201. The processor 201 performs instructions of the general program 202 of the user mobile device 200. In some embodiments, the user mobile device may store a mobile wagering app 212, which may comprise a software application the primary functionality of which is facilitating online wagering activities, but which (in accordance with embodiments described herein) also facilitates the user's participation in retail-funded jackpots, as described herein. The mobile wagering app 212 comprises instructions for directing the processor 201. Utilizing the instructions of program 202 and/or mobile wagering app 212, the processor 201 causes the user mobile device 200 to operate in accordance with at least some of the methods described in detail herein. The program 202 and/or the mobile wagering app 212 may be stored in a compressed, uncompiled and/or encrypted format. The program 202 and/or mobile wagering app 212 may furthermore include program elements that may be necessary, such as an operating system, a database management system and “device drivers” for allowing the processor 201 to interface with computer peripheral devices and/or other devices (e.g., with a jackpot management server 106, a jackpot terminal 110 and/or a wagering app server 104). Appropriate program elements are known to those skilled in the art, and need not be described in detail herein.

In accordance with some embodiments, the user mobile device 200 may be NFC-enabled. NFC, or near-field communication, is a technology that allows devices (such as a user mobile device) to share data with other NFC-equipped devices (such as a jackpot terminal 110 and/or a POS 108). When devices are NFC-enabled, an NFC connection is automatically initiated when a first NFC-enabled device (e.g., a user mobile device) comes within a predetermined close range (typically four (4) inches) of second NFC-enabled device (e.g., a jackpot terminal 110); once such two devices are within the specified (e.g., four (4) inch), the two devices may instantly communicate and send one or more prompts to the user of the user mobile device or cause an app on the user mobile device to become active and provide prompts to the user.

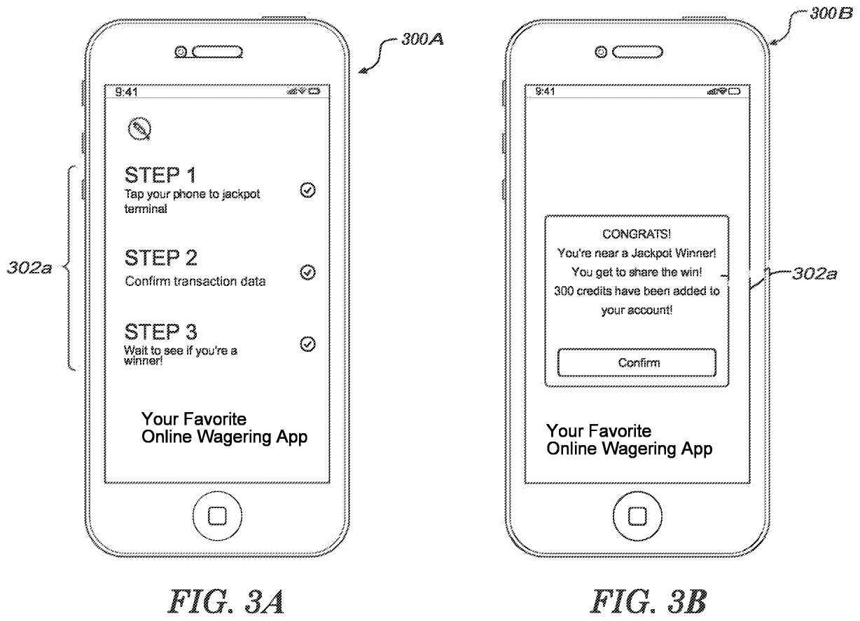

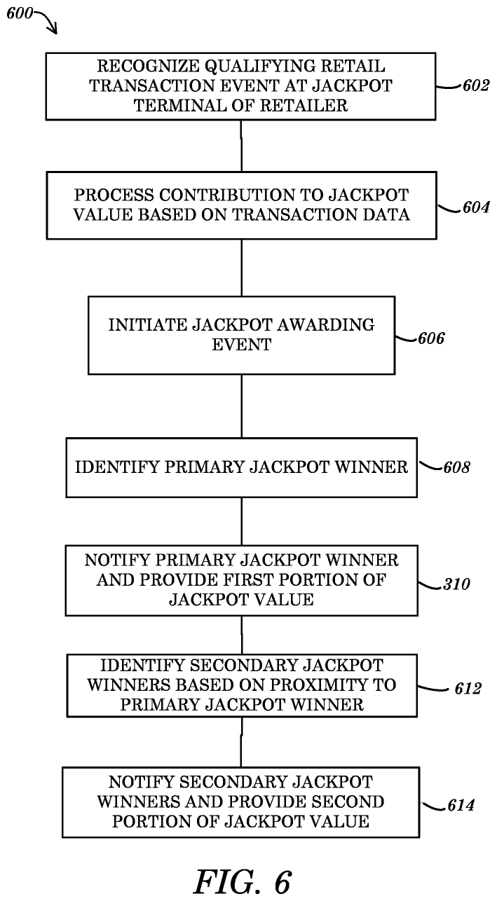

In accordance with some embodiments, an NFC-enabled user mobile device that has mobile wagering app 212 installed therein, when brought within a specified range (or “tapped”) to a jackpot terminal 110, may cause an interface of the mobile wagering app 212 to pop up on the user's mobile device and prompt the user to enter or confirm information. In other configurations using NFC technology, a user of the mobile wagering app 212 may first open the mobile wagering app 212 on their mobile device whenever the user wants to participate in the retail-funded jackpot functionality of the app (e.g., when the user is checking out at a participating retailer that has a jackpot terminal 110). In such embodiments, an interface of the mobile wagering app 212 may then prompt the user to hold the mobile device near the jackpot terminal 110 in order to have the jackpot terminal recognize a qualifying retail transaction event (and, for example, perform some of the functionality of at least some embodiments described herein, such as is described with respect to FIG. 6). An example of such a user interface of a mobile wagering app 212 is illustrated in FIG. 3A herein.

The mobile wagering app 212 may include computer program code that allows the processor 201 to, for example, employ a communication means of the user mobile device 200 to communicate with a server or other computing device (e.g., a wagering app server 104, a jackpot terminal 110, a POS 108 and/or a jackpot management server 106) in order to, for example:
1. Recognize that a qualifying retail transaction event is taking place at the POS 108;
2. Determine a unique user identifier and/or use mobile identifier corresponding to the qualifying retail transaction event (e.g., as read from the user mobile device and/or transmitted from the user mobile device or online mobile wagering app 212 of the user mobile device);
3. Determine geolocation data of the user mobile device (e.g., as stored or determinable from data stored in geolocation data 222);
4. Identify secondary jackpot winners by identifying other users of the mobile wagering app 212 or other user mobile devices that have the mobile wagering app 212 installed thereon that are within a predetermined proximity to the primary jackpot winner (or the user mobile device of such user) and/or the relevant jackpot terminal 110;
5. Transmit information, data, prompts or alerts to a user mobile device (e.g., from a jackpot management server 106 and/or wagering app server 104); and/or
6. Update a monetary amount (e.g., of currency or credits) associated with or available to the player for wagering via the mobile wagering app or otherwise associated with a balance of the player (e.g., by adding the monetary amount of the portion of a jackpot won by the player).

It should be noted that the mobile wagering app 212 may operate not just to facilitate the win of a jackpot by a primary jackpot winner and/or to cooperate with a jackpot management server to facilitate management of an increase in a jackpot value due to a qualifying retail transaction event being participated in by a user, but also to allow users who have the mobile wagering app 212 installed on their mobile devices to be eligible to share in the win of a jackpot by a primary jackpot winner by being selected as secondary jackpot winners. As described, in accordance with some embodiments, users who have the mobile wagering app 212 installed on their mobile devices may be selected as secondary jackpot winners if they are within a predetermined proximity to a primary jackpot winner (or the mobile device of such primary jackpot winner) and/or a predetermined proximity to a jackpot terminal, within a predetermined window of time from when the primary jackpot winner is determined.

In accordance with some embodiments, the geolocation data 222 of a mobile device during such window of time may be utilized to determine which users may qualify as secondary jackpot winners. In some embodiments, the mobile wagering app 212 may also facilitate one or more of the following functionalities (which may be carried out, for example, with the assistance of wagering app server 104 and/or jackpot management server 106): (i) determine geolocation data from one or more location data sources (e.g., mobile user devices of users registered with the wagering app server 104 and/or jackpot terminals 110); (ii) analyze geolocation data (e.g., in accordance with geolocation analysis rules) to determine a location of a user and/or user mobile device; and/or (iii) determine whether a user is eligible to be selected as a secondary jackpot winner (e.g., based on a determined location of the user's mobile device).

The memory 203 also stores geolocation data 222, for storing geolocation data of the user mobile device 200. Such geolocation data may be updated periodically, continuously, in response to different events, upon request, etc. Geolocation data may comprise any data or information that can be used to identify the mobile device's physical location. An example description of how geolocation data of a user's mobile device may be accessed and utilized to determine a user's location and whether the user is within a prescribed location (e.g., within a predetermined distance from a primary jackpot winner and/or a particular jackpot terminal 110) is described in Applicant's PCT Patent Application No. PCT/M2014/064837, titled SYSTEMS FOR GEOLOCATION PLATFORM MECHANICS, filed Sep. 25, 2014 and published as Publication No. WO2015/044896 on Apr. 2, 2015, is incorporated by reference herein for all purposes. As described herein, in some embodiments geolocation data is not utilized and thus geolocation data 222 may not be stored on a user mobile device 200 (e.g., BLUETOOTH technology may be utilized as an alternative technology for determining users who are in proximity to a given user mobile device 102 and/or jackpot terminal 110).

According to an embodiment, the instructions of the program 202 and/or the mobile wagering app 212 may be read into a main memory from another computer-readable medium, such from a ROM to RAM. Execution of sequences of the instructions in the program 202 and/or the mobile wagering app 212 causes processor 201 to perform the process steps described herein. In alternate embodiments, hard-wired circuitry may be used in place of, or in combination with, software instructions for implementation of the processes of the present invention. Thus, embodiments of the present invention are not limited to any specific combination of hardware and software.

In some embodiments a device remote from the user mobile device 200 (e.g., a wagering app server 104, a jackpot management server 106 or another device) may be operable to configure the user mobile device 200 remotely, update software stored on the user mobile device 200 and/or to download software or software components to user mobile device 200. For example, a wagering app server 104 may be operable to download (e.g., at the request of a user) software to the user mobile device 200 that facilitates the mobile device in or corresponding user being eligible to be selected as a primary jackpot winner and/or a secondary jackpot winner and/or having the user's purchases at participating retailers be recognized as qualifying retail transaction events. In one example, a user may download the mobile wagering app 212 to the user mobile device and, each time the user accesses the mobile wagering app 212 at a participating retailer by tapping the mobile device to a jackpot terminal 110 it may be programmed to communicate with a server (e.g., wagering app server 104 and/or the jackpot management server 106) to trigger a contribution of a retail-funded jackpot (e.g., by an amount based on a purchase total of the user's current transaction at the retailer) and determine whether the user has been selected as a primary jackpot winner.

Although not illustrated in FIG. 2, the user mobile device 200 or another device of system 100 may comprise additional components, such as an input device to facilitate input and/or an output device to facilitate output. An input device, as the term is used herein, may be any device, element or component (or combination thereof) that is capable of receiving an input (e.g., from a user or another device). An input device may communicate with or be part of another device. Some examples of input devices include: a bar-code scanner, a magnetic stripe reader, a computer keyboard or keypad, a button (e.g., mechanical, electromechanical or “soft”, as in a portion of a touch-screen), a handle, a keypad, a touch-screen, a microphone, an infrared sensor, a voice recognition module, a coin or bill acceptor, a sonic ranger, a computer port, a video camera, a motion detector, a digital camera, a network card, a universal serial bus (USB) port, a GPS receiver, a radio frequency identification (RFID) receiver, an RF receiver, a thermometer, a pressure sensor, an infrared port, and a weight scale. An output device may comprise any device, component or element (or a combination thereof) operable to output information from any of the devices described herein. Examples of an output device include, but are not limited to, a display (e.g., in the form of a touch screen), an audio speaker, an infra-red transmitter, a radio transmitter, an electric motor, a dispenser, an infra-red port, a Braille computer monitor, and a coin or bill dispenser. In some embodiments, the user mobile device 200 or another device of system 100 may comprise components capable of facilitating both input and output functions (i.e., input/output devices). In one example, a touch-sensitive display screen comprises an input/output device (e.g., the device outputs graphics and receives selections from an authorized person).

Referring now to FIG. 4, a block diagram of an apparatus 400 according to some embodiments is shown. In some embodiments, the apparatus 400 may be similar in configuration and/or functionality to a wagering app server 104 of system 100 (FIG. 1) and may comprise one or more server devices, working in series or parallel. The apparatus 400 may, for example, execute, process, facilitate, and/or otherwise be associated with the methods described in this disclosure as being carried out by a wagering app server or entity supporting a mobile wagering app that also includes the retail-funded jackpot functionality as described herein. For example, in one embodiment the apparatus 400 may be operable to support, as its primary purpose, the functionality of the mobile wagering app 212 (FIG. 2) as stored on user mobile devices of users who subscribe to, or are registered users of, the mobile wagering app (e.g., storing and updating a credit balance of each user, recognizing online wagers placed by users and tracking the status of such wagers, outputting information regarding the results of such wagers to the users, etc.).

In accordance with some embodiments described herein, the apparatus 400 may also support some of the functionality related to managing and distributing retail-funded jackpots as described herein, and particularly facilitate communications to or among one or more of a mobile user device 102, a jackpot terminal 110 and jackpot management server 106. For example, the apparatus 400 may update a credit balance of a user, as tracked in a mobile wagering app account for that user, based on a win of a retail-funded jackpot by that user. For example, if a user is selected as a primary jackpot winner or a secondary jackpot winner by the jackpot management server 106, the wagering app server 104 as embodied by apparatus 400 may receive an indication of the jackpot value of a retail-funded jackpot that has been won by that user (and an indication of identity of that user), such that the credit balance of that user can be updated to reflect the jackpot value that has been won.

In some embodiments, the apparatus 400 may comprise an electronic and/or computerized controller device, such as a computer server communicatively coupled to interface with the user mobile devices 102, jackpot terminals 110 and/or the jackpot management server 106 (any of these communications being direct and/or indirect, depending on the desired configuration of the system 100). The apparatus 400 may, for example, comprise one or more PowerEdge™ R840 rack servers manufactured by Dell®, Inc. of Round Rock, TX, which may include one or more Twelve-Core Intel® Xeon® E5-4640 v4 electronic processing devices. In some embodiments, the apparatus 400 may comprise a plurality of processing devices specially programmed to execute and/or conduct processes that are not practicable without the aid of the apparatus 400. The apparatus 400 may, for example, execute wagering game and/or retail-funded jackpot communication instructions that are operable to process hundreds or thousands of wager transactions and/or qualifying retail transaction events (e.g., from the mobile user devices 102 and/or from jackpot terminals 110) simultaneously, as described herein. In some configurations, the apparatus 400 may comprise a plurality of electronic processing devices located at one or more various sites and/or locations that cooperate to provide the functionality described with respect to apparatus 400 and/or wagering app server 104.

In some embodiments, the apparatus 400 may comprise a processor 410, an input device 406, an output device 480, a communication device 460, and/or a memory device 408. According to some embodiments, any or all of the components 410, 406, 480, 460, 408 of the apparatus 400 may be similar in configuration and/or functionality to any similarly named and/or numbered components described in this disclosure. Fewer or more components 410, 406, 480, 460, 408 and/or various configurations of the components 410, 406, 480, 460, 408 may be included in the apparatus 400 without deviating from the scope of embodiments described in this disclosure.

According to some embodiments, the processor 410 may be or include any type, quantity, and/or configuration of electronic and/or computerized processor that is or becomes known. The processor 410 may comprise, for example, an Intel® DT 2800 network processor or an Intel® XEON™ Processor coupled with an Intel® E7501 chipset. In some embodiments, the processor 410 may comprise multiple inter-connected processors, microprocessors, and/or micro-engines. According to some embodiments, the processor 410 (and/or the apparatus 400 and/or portions thereof) may be supplied power via a power supply (not shown) such as a battery, an Alternating Current (AC) source, a Direct Current (DC) source, an AC/DC adapter, solar cells, and/or an inertial generator. In the case that the apparatus 400 comprises a server such as a blade server, necessary power may be supplied via a standard AC outlet, power strip, surge protector, a PDU, and/or Uninterruptible Power Supply (UPS) device.

In some embodiments, the input device 406 and/or the output device 480 are communicatively coupled to the processor 410 (e.g., via wired and/or wireless connections and/or pathways) and they may generally comprise any types or configurations of input and output components and/or devices that are or become known, respectively.

In some embodiments, the communication device 460 may comprise any type or configuration of communication device that is or becomes known or practicable. The communication device 460 may, for example, comprise a network interface card (NIC), a telephonic device, a cellular network device, a router, a hub, a modem, and/or a communications port or cable. In some embodiments, the communication device 460 may be coupled to provide data to a user device (not shown in FIG. 4), such as in the case that the apparatus 400 is utilized to update data output on a user interface of a mobile wagering app installed on a user mobile device (e.g., as illustrated in FIGS. 3A and 3B herein). The communication device 460 may, for example, comprise a cellular telephone network transmission device that sends signals indicative of user interface components (such as specific screen to be popped up on the user's mobile device and/or specific information or data to be output to the user) to a user mobile device. According to some embodiments, the communication device 460 may also or alternatively be coupled to the processor 410. In some embodiments, the communication device 460 may comprise an IR, RF, Bluetooth™, and/or Wi-Fi® network device coupled to facilitate communications between the processor 410 and another device (such as a user mobile device and/or a third-party device).

The apparatus 400 may also be operable to communicate with, or access, one or more database (e.g., a user database that stores user account information, a wager database that stores information related to wagers placed by users, etc.) and/or data (e.g., data related to users registered with the provider of the supported mobile wagering app and/or user mobile devices on which the supported wagering app is stored, if the settings of such app are configured by the user so as to allow the apparatus 400 to access such databases and/or data). Such databases and/or data may store data defining a location of the user mobile device on which such app is installed and/or the user mobile device that is currently participating in a qualifying retail transaction event, or other account or profile information of the user corresponding to the user mobile device. In some embodiments, such a database may be stored in a memory or storage device of the apparatus 400 while in other embodiments such a database may be stored in a memory or storage device of a device distinct from (or that is a component of) the apparatus 400, with which the apparatus 400 is operable to communicate with in order to at least access the data in such a database.

In some embodiments processor 410 (e.g., one or more microprocessors, one or more microcontrollers, one or more digital signal processors) of the apparatus 400 may receive instructions (e.g., from a memory or like device), and execute those instructions, thereby performing one or more processes defined by those instructions. Instructions may be embodied in, e.g., one or more computer programs, modules, subroutines and/or scripts. Memory device 408 is one example of where and how such instructions in may be stored. The memory device 408 may comprise any appropriate information storage device that is or becomes known or available, including, but not limited to, units and/or combinations of magnetic storage devices (e.g., a hard disk drive), optical storage devices, and/or semiconductor memory devices such as RAM devices, Read Only Memory (ROM) devices, Single Data Rate Random Access Memory (SDR-RAM), Double Data Rate Random Access Memory (DDR-RAM), and/or Programmable Read Only Memory (PROM). As illustrated in FIG. 4, in accordance with some embodiments the memory device 408 may store: (i) wagering app instructions 412-1; (ii) retail-funded jackpot communication instructions 412-2; (iii) user data 422-1; and (iv) geolocation data 422-2.

The user data 422-1 may comprise, for example, data defining one or more users comprising subscribers or registered users of the mobile wagering app supported by the apparatus 400 (e.g., user login credentials, banking or financial information (such as a balance of credits available for wagering or cashout by the user), contact information, corresponding user mobile device information, historical and current wager information corresponding to each user, etc.).

The geolocation data 422-2 may comprise data indicating a past and/or current physical location of the user mobile devices of users of the mobile wagering app. The geolocation data may be updated on a periodic, continuous or other (e.g., upon request, upon the user actively using the mobile wagering app, etc.) basis and may be created from a signal from the corresponding user mobile device. Example sources of such geolocation data include, without limitation: (i) GPS; (ii) cellular network data (e.g., using triangulation of cellular towers); (iii) Internet (e.g., IP address corresponding to where user is currently accessing the internet from); (iv) WiFi network data (e.g. the network's SSID (service set identifier)); (v) transaction data (e.g., using a POS or jackpot terminal near which a user mobile device is located); and (vi) BLUETOOTH data (e.g., using the location of a POS or jackpot terminal near which a user mobile device is located and the fact that the user mobile device is within the BLUETOOTH range of such POS or jackpot terminal).

The wagering app instructions 412-1 may comprise one or more modules or subroutines for supporting wagering functionality of the mobile wagering app. Non-limiting examples of the foregoing include: recognizing wagers made, tracking status of wagers, collecting wagers, providing payouts for wagers won by adding the payout to a credit balance of the appropriate user and/or pushing out notifications and updates on available wagers or pending wagers to the corresponding users.

According to some embodiments, the retail-funded jackpot communication instructions 412-2 may be operable to cause the processor 410 to process user data 422-1 and/or geolocation data 422-2. User data 422-1 and/or geolocation data 422-2 may be received via the input device 406 and/or the communication device 460 and, for example, be analyzed, sorted, filtered, decoded, decompressed, ranked, scored, plotted, and/or otherwise processed by the processor 410 in accordance with the retail-funded jackpot communication instructions 412-2.

For example, the retail-funded jackpot communication instructions 412-2 may comprise one or more modules or subroutines for managing communication of data related to the retail-funded jackpot functionality of the mobile wagering app. Non-limiting examples of the foregoing include: (i) receiving an indication from a user that the user is participating in a qualifying retail transaction event and/or communicate such indication to the jackpot management server 106; (ii) receiving an indication from the jackpot management server 106 that a particular user has been selected as a primary jackpot winner (including the jackpot value that has been won); (iii) transmitting an indication to the selected user's mobile device an indication of the win and/or increasing a credit balance associated with the selected user by the appropriate jackpot value; (iv) providing user and/or user mobile device information to a jackpot management server 106 (such as a current location or status of a particular user mobile device or information identifying a user selected as a primary jackpot winner); and/or (v) identifying one or more users based on information received from a jackpot management server 106 (e.g., identifying one or more secondary jackpot winners based on proximity of such secondary users to a primary jackpot winner selected by a jackpot management server 106, based on geolocation data accessible to the apparatus 400, etc.).

Any or all of the exemplary instructions and data types described in this disclosure and other practicable types of data may be stored in any number, type, and/or configuration of memory devices that is or becomes known. The memory device 408 may, for example, comprise one or more data tables or files, databases, table spaces, registers, and/or other storage structures. In some embodiments, multiple databases and/or storage structures (and/or multiple memory devices 408) may be utilized to store information associated with the apparatus 400. According to some embodiments, the memory device 408 may be incorporated into and/or otherwise coupled to the apparatus 400 (e.g., as shown) or may simply be accessible to the apparatus 400 (e.g., externally located and/or situated).

Referring now to FIG. 5, a block diagram of an example apparatus 500 according to some embodiments is shown. In some embodiments, the apparatus 500 may be similar in configuration and/or functionality to a jackpot management server 106 of system 100 (FIG. 1) and may comprise one or more server devices, working in series or parallel. The apparatus 500 may, for example, execute, process, facilitate, and/or otherwise be associated with the methods described in this disclosure as being carried out by a jackpot management server or entity supporting a mobile wagering app that also includes the retail-funded jackpot functionality as described herein. For example, in one embodiment the apparatus 500 may be operable to support, as its primary purpose, the management of one or more retail-funded jackpots (e.g., increasing and tracking of current jackpot values of the respective jackpot(s), determining whether recognized retail transaction events comprise qualifying retail transaction events) and distribution thereof (e.g., performing functionality to support jackpot awarding events, to select primary jackpot winners and secondary jackpot winners).

In accordance with some embodiments described herein, the apparatus 500 may also support communications to or among mobile user devices 102, jackpot terminals 110 and/or wagering app server 104. For example, the apparatus 500 may perform a jackpot awarding event to select a primary jackpot winner and communicate a win of a retail-funded jackpot to a user mobile device corresponding to the selected user (either directly or via one or more of a wagering app server 104 and a jackpot terminal 110).

In some embodiments, the apparatus 500 may comprise an electronic and/or computerized controller device, such as a computer server communicatively coupled to interface with one or more user mobile devices 102, one or more jackpot terminal 110 and/or the wagering app server 104 (any of these communications being direct and/or indirect, depending on the desired configuration of the system 100). The apparatus 500 may, for example, comprise one or more PowerEdge™ R840 rack servers manufactured by Dell®, Inc. of Round Rock, TX, which may include one or more Twelve-Core Intel® Xeon® E5-4640 v4 electronic processing devices. In some embodiments, the apparatus 500 may comprise a plurality of processing devices specially programmed to execute and/or conduct processes such as (i) executing retail-funded jackpot instructions that are operable to process hundreds or thousands of qualifying retail transaction events (e.g., as recognized based on signals or data received from one or mobile user devices 102, a wagering app server 104, a POS 108 and/or one or more jackpot terminals 110) simultaneously, as described herein (e.g., to update, track and increase the respective value of one or more jackpots being managed); and (ii) executing retail-funded jackpot distribution instructions to identify jackpot winners (e.g., facilitate an jackpot awarding event) upon determining a trigger for such an event. In some configurations, the apparatus 500 may comprise a plurality of electronic processing devices located at one or more various sites and/or locations that cooperate to provide the functionality described with respect to apparatus 500 and/or jackpot management server 106.

In some embodiments, the apparatus 500 may comprise a processor 510, an input device 506, an output device 580, a communication device 560, and/or a memory device 508. According to some embodiments, any or all of the components 510, 506, 580, 560, 508 of the apparatus 500 may be similar in configuration and/or functionality to any similarly named and/or numbered components described in this disclosure. Fewer or more components 510, 506, 580, 560, 508 and/or various configurations of the components 510, 506, 580, 560, 508 may be included in the apparatus 500 without deviating from the scope of embodiments described in this disclosure.

According to some embodiments, the processor 510 may be or include any type, quantity, and/or configuration of electronic and/or computerized processor that is or becomes known. The processor 510 may comprise, for example, an Intel® DT 2800 network processor or an Intel® XEON™ Processor coupled with an Intel® E7501 chipset. In some embodiments, the processor 510 may comprise multiple inter-connected processors, microprocessors, and/or micro-engines. According to some embodiments, the processor 510 (and/or the apparatus 500 and/or portions thereof) may be supplied power via a power supply (not shown) such as a battery, an Alternating Current (AC) source, a Direct Current (DC) source, an AC/DC adapter, solar cells, and/or an inertial generator. In the case that the apparatus 500 comprises a server such as a blade server, necessary power may be supplied via a standard AC outlet, power strip, surge protector, a PDU, and/or Uninterruptible Power Supply (UPS) device.

In some embodiments, the input device 506 and/or the output device 580 are communicatively coupled to the processor 510 (e.g., via wired and/or wireless connections and/or pathways) and they may generally comprise any types or configurations of input and output components and/or devices that are or become known, respectively.

In some embodiments, the communication device 560 may comprise any type or configuration of communication device that is or becomes known or practicable. The communication device 560 may, for example, comprise a network interface card (NIC), a telephonic device, a cellular network device, a router, a hub, a modem, and/or a communications port or cable. In some embodiments, the communication device 560 may be coupled to provide data to a user device (not shown in FIG. 5), such as in the case that the apparatus 500 is utilized to update data output on a user interface of a mobile wagering app installed on a user mobile device (e.g., as illustrated in FIGS. 3A and 3B herein). The communication device 560 may, for example, comprise a cellular telephone network transmission device that sends signals indicative of user interface components (such as specific screen to be popped up on the user's mobile device and/or specific information or data to be output to the user) to a user mobile device. According to some embodiments, the communication device 560 may also or alternatively be coupled to the processor 510. In some embodiments, the communication device 560 may comprise an IR, RF, Bluetooth™, and/or Wi-Fi® network device coupled to facilitate communications between the processor 510 and another device (such as a user mobile device and/or a third-party device).

The apparatus 500 may also be operable to communicate with, or access, one or more database (e.g., a jackpot database that stores information regarding one or more jackpots being managed by the apparatus 500, a jackpot terminal database that stores information related to jackpot terminals that are part of the network of devices operable to support the retail-funded jackpot functionality described herein, etc.) and/or data (e.g., data related to jackpots, jackpot values, jackpot winners, users registered with the provider of the supported mobile wagering app and/or user mobile devices on which the wagering app that includes a retail-funded jackpot feature is stored, if the settings of such app are configured by the user so as to allow the apparatus 500 to access such databases and/or data). Such databases and/or data may store data defining a location of the jackpot terminal located at a physical retailer at which a user is currently participating in a qualifying retail transaction event, or other information relevant to managing and distributing a retail-funded jackpot as described herein. In some embodiments, such a database may be stored in a memory or storage device of the apparatus 500 while in other embodiments such a database may be stored in a memory or storage device of a device distinct from (or that is a component of) the apparatus 500, with which the apparatus 500 is operable to communicate with in order to at least access the data in such a database.

In some embodiments, processor 510 (e.g., one or more microprocessors, one or more microcontrollers, one or more digital signal processors) of the apparatus 500 may receive instructions (e.g., from a memory or like device), and execute those instructions, thereby performing one or more processes defined by those instructions. Instructions may be embodied in, e.g., one or more computer programs, modules, subroutines and/or scripts. Memory device 508 is one example of where and how such instructions in may be stored. The memory device 508 may comprise any appropriate information storage device that is or becomes known or available, including, but not limited to, units and/or combinations of magnetic storage devices (e.g., a hard disk drive), optical storage devices, and/or semiconductor memory devices such as RAM devices, Read Only Memory (ROM) devices, Single Data Rate Random Access Memory (SDR-RAM), Double Data Rate Random Access Memory (DDR-RAM), and/or Programmable Read Only Memory (PROM). As illustrated in FIG. 5, in accordance with some embodiments the memory device 508 may store: (i) retail-funded jackpot management instructions 512-1; (ii) retail-funded jackpot distribution instructions 512-2; (iii) jackpot data 522-1; and (iv) jackpot terminal data 522-2.

The jackpot data 522-1 may comprise, for example, data defining one or more retail-funded jackpots being managed by the apparatus 500 and/or data usable for jackpot awarding events. This data may comprise, for example, a current value and status of a jackpot. In some embodiments, this data may comprise include historical jackpot data (e.g., value of jackpot previously awarded, primary jackpot winner information, secondary jackpot winner information, information regarding prior jackpot awarding events and corresponding results thereof, etc.). In some embodiments, this data may also comprise one or more distribution criteria that may need to be satisfied in order for a particular corresponding jackpot to be distributed during a jackpot awarding event (e.g., the jackpot value must be at least a minimum predetermined value, etc.).

In some embodiments, for a given jackpot awarding event or for a given contribution to a jackpot value responsive to recognizing a qualifying retail transaction event, there may only be a single jackpot for the system to utilize. For example, there may only be a single jackpot at any given time that all participating users (e.g., users who are registered users of the relevant mobile wagering app and who choose to have their retail transactions at participating retailers be counted as qualifying retail transaction events that trigger an increase in the jackpot value and a jackpot awarding event) have a chance to win. In other embodiments, multiple jackpots may be managed and available for winning and for increasing the respective value thereof. For example, there may be different jackpots for (i) different geographic regions; (ii) types or categories of participating retailers (e.g., service retailers vs. goods retailers, or retailers who elect to pay to have their customers/users eligible for a higher value jackpot in order to attract more customers/users to their establishments, etc.); (iii) different times of day, week, month or year; (iv) different characteristics or other eligibility criteria corresponding to users (e.g., users corresponding to a first category or level, as assigned by the mobile wagering app such as based on wagering or non-wagering activity, may be eligible to win a first jackpot while users corresponding to a second category or jackpot may be eligible to win a second jackpot; users who have wagered within the last week are eligible to win a higher value jackpot than users who have not); (v) different transaction characteristics of a qualifying transaction event that triggers a jackpot awarding event (e.g., if the purchase total is at least a predetermined amount, the user is eligible to win a higher value jackpot than if the purchase total is less than the predetermined amount); and/or (vi) special promotions currently being supported for certain retailers, purchases, users, etc. In some embodiments, the jackpot management server 106 may select which of a plurality of available and eligible jackpots a contribution is to be made to for a given qualifying retail transaction event, while in other embodiments a user may be provided with an opportunity to make such a selection (e.g., via an interface of the mobile wagering app on the user mobile device, upon the user tapping his user mobile device to a jackpot terminal or otherwise initiating or indicating participation in a qualifying retail transaction event).

The jackpot terminal data 522-2 may comprise, for example, data defining one or more jackpot terminals 110 placed at respective Brick 'N Mortar retailers 120. Non-limiting examples of such data include: (i) a unique identifier of the jackpot terminal 110; (ii) a location of the jackpot terminal (e.g., retailer at which it is located, geolocation data, IP address data, physical address of location at which the jackpot terminal is located, etc.); (iii) contact information and/or instructions for communicating with the jackpot terminal; (iv) a POS 108 associated with the jackpot terminal; and (v) a current status of the jackpot terminal (e.g., active, offline, processing a qualifying retail event transaction, etc.).

The retail-funded jackpot management instructions 512-1 may, in accordance with some embodiments, comprise one or more modules or subroutines for updating and maintaining the value and status of one or more jackpots being managed by the apparatus 500. Non-limiting examples of the foregoing include: recognizing the occurrence of retail transaction events, communicating with jackpot terminals (and/or user mobile devices 102 or POSs 108 in order to obtain data regarding the foregoing), determining whether a recognized transaction event is a qualifying retail transaction event, increasing a jackpot value responsive to recognizing a qualifying retail transaction event, managing a budget or account of monetary funds available for making contributions to one or more jackpot values, updating the status of a given jackpot and/or pushing out notifications and updates on managed jackpots to users, participating retailers and other devices of system 100. The retail-funded jackpot management instructions 512-1 may, for example, be utilized in steps 602 and 604 of process 600 (FIG. 6)

The retail-funded jackpot distribution instructions 512-2 may, in accordance with some embodiments, comprise one or more modules or subroutines for facilitating jackpot awarding events. Non-limiting examples of the foregoing include: identifying a primary jackpot winner, identifying secondary jackpot winners, facilitating notifications to both of the foregoing based on a jackpot value win, and facilitating an increase in available credits or other monetary funds to either of the foregoing based on a jackpot value win. The retail-funded jackpot distribution instructions 512-2 may, for example, be utilized in steps 606-614 of process 600 (FIG. 6).

According to some embodiments, the retail-funded jackpot management instructions 512-1 and/or the retail-funded jackpot distribution instructions 512-2 may be operable to cause the processor 510 to update, analyze, sort, filter, decode, decompress and/or otherwise process jackpot data 522-1 and/or jackpot terminal data 522-2.

Referring now to FIG. 6, a flow diagram of a process 600 according to some embodiments is shown. It should be noted that process 300 is exemplary only and should not be construed in a limiting fashion. The process 600 may be performed, for example, by jackpot management server 106 (FIG. 1) and/or a combination of jackpot management server 106 with other components of the system 100 (e.g., wagering app server 104, one or more user mobile devices 102, one or more jackpot terminals 110 and one or more POSs 108), in order to facilitate at least some of the embodiments described herein.

The process diagrams and flow diagrams described herein do not necessarily imply a fixed order to any depicted actions, steps, and/or procedures, and embodiments may generally be performed in any order that is practicable unless otherwise and specifically noted. Any of the processes and methods described herein may be performed and/or facilitated by hardware, software (including microcode), firmware, or any combination thereof. For example, a storage medium (e.g., a hard disk, data storage device, Random Access Memory (RAM) device, cache memory device, Universal Serial Bus (USB) mass storage device, and/or Digital Video Disk (DVD)) may store thereon instructions that when executed by a machine (such as a computerized processor) result in performance according to any one or more of the embodiments described in this disclosure.

According to some embodiments, processes described herein may be performed and/or implemented by and/or otherwise associated with one or more specialized and/or computerized processing devices (e.g., the devices described herein, such as with reference to system 100 of FIG. 1), specialized computers, computer terminals, computer servers, computer systems and/or networks, and/or any combinations thereof. In some embodiments, methods may be embodied in, facilitated by, and/or otherwise associated with various input mechanisms and/or interfaces.

Any processes described in this disclosure do not necessarily imply a fixed order to any depicted actions, steps, and/or procedures, and embodiments may generally be performed in any order that is practicable unless otherwise and specifically noted. Any of the processes and/or methods described in this disclosure may be performed and/or facilitated by hardware, software (including microcode), firmware, or any combination thereof. For example, a storage medium (e.g., a hard disk, Universal Serial Bus (USB) mass storage device, and/or Digital Video Disk (DVD)) may store thereon instructions that when executed by a machine (such as a computerized processing device) result in performance according to any one or more of the embodiments described in this disclosure.

The process 600 begins with a qualifying retail transaction event being recognized (step 602). Recognizing a qualifying retail transaction event may comprise, for example, receiving data, information or a signal from another device (e.g., from a jackpot terminal 110, a POS 108, a user mobile device 102 or a wagering app server 104), indicating the qualifying retail transaction event is occurring. In some embodiments, a user may initiate such a signal or indication by, for example, tapping his/her mobile user device to an NFC-enabled jackpot terminal. Such an action may, for example, cause a user interface corresponding to the retail-funded jackpot functionality of the mobile wagering app 212 to pop up on the user mobile device and prompt the user to provide certain information. In other embodiments, a user may first open the mobile wagering app 212 during a retail transaction at a participating retailer and be prompted via an interface thereof to interact with a jackpot terminal 110 of the retailer in a predetermined manner. Interface 300A (FIG. 3A) illustrates, in area 302a, one example embodiment of an interface that may be output to a user who is near an NFC-enabled jackpot terminal 110.

In some embodiments, a worker (e.g., cashier) of the participating retailer may initiate an indication of the retail transaction event to be transmitted to the jackpot management server 106 and/or the wagering app server 104 (e.g., via a jackpot terminal 110 or POS 108). In some embodiments, a jackpot terminal 110 may automatically detect a nearby mobile user terminal that has the online wagering app 212 installed (e.g., via BLUETOOTH functionality) and transmit a signal to the mobile user device that causes an interface of the app to pop up and/or a signal to be transmitted to the jackpot management server 106.

In some embodiments, step 602 may comprise receiving or obtaining data indicating a physical location of the user corresponding to the qualifying retail transaction event. Such data may comprise, for example, geolocation data of the user mobile device (e.g., as received directly from the user mobile device or from the wagering app server 104) or geolocation data of the jackpot terminal involved in the qualifying retail transaction event (e.g., a location associated with the jackpot terminal in a jackpot terminal database accessible to the device performing the process 600, such as jackpot terminal data 522-2).

In accordance with some embodiments, step 602 may include processing received transaction data to determine whether the retail transaction event comprises a qualifying retail transaction event (i.e., a retail transaction event that causes a contribution or increase to be made to a jackpot value), or such a determination may be done via an additional step or subroutine of process 600. For example, in some embodiments, qualifying criteria may need to be satisfied in order for a retail transaction event to be considered a qualifying retail transaction event. Examples of such qualifying criteria include, without limitation: (i) the retail transaction event must be taking place at a particular retailer or group of retailers, (ii) the purchase total of the relevant retail transaction must be at least a minimum amount, (iii) the user (or characteristic thereof) associated with the retail transaction event must satisfy a predetermined condition; and/or (iv) the relevant retail transaction must be occurring during a particular window of time, on a particular day, date, time of day, week, month or year, etc. (i.e., within a jackpot eligibility period).

Upon recognizing a qualifying retail transaction event, a contribution (e.g., a monetary amount or value by which the current value of the jackpot is increased) is made to a jackpot value of a retail-funded jackpot, the contribution being based on transaction data (step 604). Such transaction data may comprise, for example, a purchase total of the qualifying retail transaction event. In some embodiments, the contribution to the jackpot value may be calculated based on the purchase total (e.g., the contribution amount may be a percentage (e.g., 1-5%, depending on the desired configuration). In other embodiments, the contribution value may be a predetermined amount or an amount unrelated to the purchase total. In some embodiments, the contribution value may be determined in accordance with an algorithm or formula. For example, in one embodiment there may be a plurality of potential contribution values from which a particular contribution value is selected based on a random process (e.g., a process driven by a random number generator or similar scheme). Various other criteria based upon which the contribution value may be determined are possible and the embodiments described herein are not dependent on any particular such scheme.

In accordance with some embodiments, a contribution to a jackpot value may be funded by the provider of the online wagering app that includes a retail-funded jackpot feature. For example, the provider of the online wagering app may fund the jackpot(s) out of a marketing or promotions budget, as a means of attracting and retaining users to its online mobile wagering app. In other embodiments, the jackpot contributions may be funded by participating retailers (e.g., who want to attract users to their retail establishments and thereby fund jackpots that can be won by users who make purchases at their establishments).

In accordance with some embodiments, a jackpot awarding event is also triggered upon a qualifying retail transaction event being recognized. Accordingly, step 606 of process 600 comprises initiating a jackpot awarding event. Although step 606 is illustrated as occurring after steps 604 and 602, it should be understood that such an order or sequencing is not required (e.g., steps 602 and 606 may occur in parallel). In some embodiments, the timing of a jackpot awarding event being initiated may be unrelated in some embodiments to the timing of a qualifying retail transaction event being recognized. In some embodiments, a jackpot awarding event may be performed at a time, or in response to a trigger, other than the recognizing of a qualifying retail transaction event or only for a subset of qualifying retail transaction events (e.g., only for a subset of qualifying retail transaction events selected at random or in accordance with a desired algorithm, or only once a jackpot value reaches a threshold value).

A jackpot awarding event may comprise applying a jackpot awarding subroutine or algorithm to determine whether the user corresponding to the qualifying retail transaction event wins the jackpot. In some embodiments, such an algorithm may comprise a random process similar to a random number generator process applied to determining outcomes for slot machines or wagering games. The embodiments described herein are not dependent on any particular methodology or scheme for determining a result of a jackpot awarding event.

Process 600 presumes that the outcome or result of a jackpot awarding event is a determination or identification of a primary jackpot winner (i.e., there is a win of the jackpot as a result of the event). In scenarios where the result of the jackpot awarding event is that no primary jackpot winner is identified or selected (because not all jackpot awarding events will result in primary jackpot winners being identified or a jackpot being won), the process 600 may end after the result of step 606 is determined to not be a win of the jackpot. In accordance with some embodiments, the jackpot awarding event that is triggered by a qualifying retail transaction event is performed in order to determine whether the particular user involved in the qualifying retail transaction is a primary jackpot winner of the jackpot that was increased as a result of the qualifying retail transaction. Thus, step 606 consists of determining whether the user corresponding to the qualifying retail transaction recognized in step 602 is a primary jackpot winner (e.g., using an algorithm similar to an RNG utilized for determining outcomes of wagering games, such as slot-style wagering games).

In embodiments in which multiple jackpots are being managed and available to be won, step 606 (or another step of process 600) may comprise selecting which of the plurality of available jackpots is won. In some embodiments, this may comprise applying one or more rules for selecting a jackpot or selecting a jackpot at random. In some embodiments, the jackpot that is the subject of the jackpot awarding event may be the same jackpot to which a contribution was made as a result of the qualifying retail transaction event recognized in step 602, in which case a further selection of a jackpot from a plurality of jackpots may not be necessary. In some embodiments in which multiple jackpots are available to be won, step 606 may comprise performing a jackpot awarding event for each such jackpot (or a subset/plurality thereof) in order to determine whether any of these jackpots have been won.

Presuming the result of step 606 is a win of a jackpot, step 608 comprises identifying the primary jackpot winner. In the example embodiment being illustrated via process 600, step 606 is being performed in order to determine whether the user who is participating in the qualifying retail transaction event recognized in step 602 is a winner. In such embodiments, step 608 (identifying the primary retail jackpot winner) may comprise identifying the user and/or user mobile device involved in the qualifying retail transaction event of step 602. For example, a user mobile terminal identifier (e.g., mobile telephone number) and/or user identifier (e.g., account number or user credentials for the mobile wagering app 212) may have been transmitted as part of the information or data received in step 602. In some embodiments, user data 422-1 (FIG. 4) or similar data may be accessed to correlate a user mobile device identifier to a user identifier or vice-versa.

In alternate embodiments (particularly in embodiments in which a jackpot awarding event is not also triggered and performed at the time a qualifying retail transaction is recognized), step 608 may comprise identifying a primary jackpot winner from a plurality of eligible users (e.g., all users that are within a particular location (such as proximity to a jackpot terminal), all users who have participated in qualifying retail transactions within a predetermined period of time, all users who have logged into and/or placed a wager via the mobile wagering app 212 within a predetermined period of time, etc.). The embodiments described herein are not dependent on any particular methodology for identifying a pool of users for whom a jackpot awarding event may be performed, if such pool includes users other than the user who is participating in a qualifying retail transaction that causes the jackpot awarding event to be processed.

Once a primary jackpot winner is identified, a notification of the jackpot win may be output to the user comprising the primary jackpot winner and the jackpot value (first portion of the jackpot) won by the user may be provided to the user (610). This may comprise, for example, outputting a notification of the win directly to a user mobile device 102 (e.g., a screen of the mobile wagering app 212 may pop up, with a congratulatory message for the user and an indication of the first value of the jackpot won by the user). In some embodiments, if process 600 is being performed by jackpot management server 106, step 610 may comprise communicating information (e.g., identification of the primary jackpot winner and indication of the first value) to the wagering app server 104. The wagering app server 104 may, in turn, output a notification to the primary jackpot winner via their user mobile device (e.g., using user data 222-1) and update an amount of available credits associated with the primary jackpot winner to reflect the first value. In some embodiments, the first value may be provided to the primary jackpot winner by posting a credit to a financial account associated with the primary jackpot winner other than a credit balance in an account of the user on the mobile wagering app (e.g., a credit to a credit card account, a PayPal™ account, a Venmo™ account, a bank account, etc.). In some embodiments, the first value may comprise a gift card or gift certificate to a retailer and this may be provided (in digital or physical form) to the user as part of step 610.

Once a primary jackpot winner is identified, one or more secondary users are identified, based on their proximity to the primary jackpot winner (step 612). Determining which users are within a predetermined proximity to a primary jackpot winner may comprise, for example, (i) determining which users are within a predetermined proximity to a user mobile device 102 associated with the primary jackpot winner; or (ii) determining which users are within a predetermined proximity to a jackpot terminal 110 that was involved in the qualifying retail transaction recognized in step 602 (in embodiments in which a jackpot awarding event is triggered by a qualifying retail transaction event being recognized, and performed essentially at the same time as the qualifying retail transaction recognition, since it can be presumed that the primary jackpot winner is still within proximity to the relevant jackpot terminal).

As described elsewhere in this disclosure, determining geolocation data may comprise determining a position, geographical location, GPS coordinates, and/or other type of location data, based on any of various types of location data sources, including but not limited to GPS, Wi-Fi, mobile tower site location and/or triangulation, internet protocol (IP) address, and carrier location. In some embodiments, a data source for geolocation data may be an on-device location data source (e.g., derived from or received via a user mobile device being located) or an off-device location data source (e.g., received from a user mobile device carrier).

In some embodiments, geolocation data of the primary jackpot winner's user mobile device (e.g., as received directly from the user mobile device (e.g., in step 608) or from wagering app server 104 (e.g., as embodied in apparatus 400 and based on geolocation data 422-2) may be received or identified. In embodiments in which geolocation data of jackpot terminal 110 is used, this may be retrieved from jackpot terminal data 522-2 and/or received directly from the jackpot terminal 110 (e.g., as part of the information received in step 602). Geolocation data of the primary jackpot winner's user mobile device or that of the jackpot terminal 110 may then be compared to geolocation data of other user mobile devices at the relevant time (e.g., from wagering app server 104 as embodied in apparatus 400 and based on geolocation data 422-2). Such geolocation data may be utilized to identify players

In some embodiments, a jackpot terminal 110 may be BLUETOOTH-enabled and step 612 may comprise transmitting a signal to the jackpot terminal 110 that was involved in step 602, which signal may cause the jackpot terminal 110 to “find” any user mobile devices within BLUETOOTH range that have the mobile wagering app installed thereon (and BLUETOOTH functionality enabled), thereby causing a pairing and communication between the jackpot terminal 110 and any nearby user mobile devices. Secondary jackpot winners may be selected from such set of user mobile devices that are paired.

Other methods for determining users who are within proximity to another user are know and will not be described in detail herein. For example, the technology and methods described in U.S. patent Ser. No. 10/887,937B2 to Oren Raphael, titled SYSTEM AND METHOD FOR PROXIMITY BASED NETWORKED MOBILE COMMUNICATION may be utilized.

If not secondary jackpot winners are identified in step 612 (e.g., no secondary users were identified or recognized as being within proximity to the primary jackpot winner), process 600 may end. In such embodiments, the second portion of the jackpot may be retained as part of the jackpot to be awarded in a subsequent jackpot awarding event. In other embodiments, the second portion of the jackpot may also be awarded to the primary jackpot winner.

Presuming at least one secondary jackpot winner is identified in step 612, the second portion of the jackpot may be allocated among the secondary jackpot winners and such secondary jackpot winners may be notified of their win and the amount that they have won (step 614). The value of the jackpot won by each respective secondary jackpot winner may also be provided to each such secondary jackpot winner. Step 614 may be similar to step 610 (substituting each respective secondary jackpot winner for the primary jackpot winner in the description thereof) and thus will not be described in detail herein. The user interface 300B of FIG. 3B illustrates, in area 302a, an example user interface that may be output via mobile wagering app 212 to each secondary jackpot winner to notify them of their win.

Applicant has recognized that the embodiments described herein create a novel way of distributing a jackpot to an initial winner and other subscribers or users of a mobile wagering app who are near the initial winner, based on their geo-location. One benefit of these embodiments is to be able to drive people to certain places (e.g. to certain retailers to make purchases, to certain parts of a casino, into certain shops in a shopping center, etc., in the hopes of becoming primary or secondary jackpot winners).

Although various specific embodiments and example have been described herein, the scope of the invention(s) described herein should not be construed in a limiting fashion based on any description of any particular embodiment, example or illustration. Various modifications of embodiments would be evident to one of ordinary skill in the art upon reading the present disclosure.

### Rules of Interpretation

Numerous embodiments are described in this disclosure, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the invention that must be present in all embodiments.

Neither the Title (set forth at the beginning of the first page of this disclosure) nor the Abstract (set forth at the end of this disclosure) is to be taken as limiting in any way as the scope of the disclosed invention(s).

The term “product” means any machine, manufacture and/or composition of matter as contemplated by 35 U.S.C. § 101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

The terms “the invention” and “the present invention” and the like mean “one or more embodiments of the present invention.”

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present disclosure, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this disclosure are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining, recognizing, and the like.

A “display” as that term is used herein is an area that conveys information to a viewer. The information may be dynamic, in which case, an LCD, LED, CRT, LDP, rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as standard definition (SDTV), enhanced definition (EDTV), high definition (HD), or the like. The information may likewise be static, in which case, painted glass may be used to form the display. Note that static information may be presented on a display capable of displaying dynamic information if desired.

The present disclosure frequently refers to a “control system”. A control system, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, CPU devices, computing devices, microcontrollers, digital signal processors, or like devices. Exemplary processors are the INTEL PENTIUM or AMD ATHLON processors.

The term “computer-readable medium” refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

It will be readily apparent that the various methods and algorithms described herein may be implemented by a control system and/or the instructions of the software may be designed to carry out the processes of the present invention.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein a “network” is an environment wherein one or more computing devices may communicate with one another. Such devices may communicate directly or indirectly, via a wired or wireless medium such as the Internet, Local Area Network (LAN), Wide Area Network (WAN), or Ethernet (or IEEE 802.3), Token Ring, or via any appropriate communications means or combination of communications means. Exemplary protocols include but are not limited to: BLUETOOTH™, TDMA, CDMA, GSM, EDGE, GPRS, WCDMA, AMPS, D-AMPS, IEEE 802.11 (WI-FI), IEEE 802.3, SAP, SAS™ by IGT, SUPERSAS™, OASIS™ by Aristocrat Technologies, SDS by Bally Gaming and Systems, ATP, TCP/IP, gaming device standard (GDS) published by the Gaming Standards Association of Fremont CA, the best of breed (BOB), system to system (S2S), or the like. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cellular networks, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

The present disclosure provides, to one of ordinary skill in the art, an enabling description of several embodiments and/or inventions. Some of these embodiments and/or inventions may not be claimed in the present disclosure, but may nevertheless be claimed in one or more continuing applications that claim the benefit of priority of the present disclosure.

The terms “information” and “data”, as used herein unless specified otherwise, may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

The terms “indication” and “representation”, as used herein unless specified otherwise, may refer to any indicia and/or other information indicative of or associated with a subject, item, entity, and/or other object and/or idea. As used herein, the phrases “information indicative of”, “representation of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

The term “network component,” as used herein unless specified otherwise, may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

What is claimed is:

1. A method for facilitating retail-funded jackpot functionality of a mobile wagering app, comprising:
recognizing, based on first data received from jackpot terminal corresponding to a point of sale of a physical retail store, a qualifying retail transaction event involving a first user of a mobile wagering app;
contributing, based on the first data, a monetary amount to a jackpot that users of the mobile wagering app can win without placing wagers thereon;
processing a jackpot awarding event to determine that the first user is a winner of the jackpot, thereby identifying the first user as a primary jackpot winner;
distributing, via the mobile wagering app, a first portion of the jackpot to the primary jackpot winner;
identifying, based on geolocation data associated with the primary jackpot winner, at least one second user within a predetermined proximity to the primary jackpot winner, thereby identifying at least one secondary jackpot winner; and
distributing, via the mobile wagering app, a second portion of the jackpot to the at least one secondary jackpot winner.

2. The method of claim 1, wherein the first data includes a retail value corresponding to the retail transaction and wherein the monetary amount is based on the retail value.

3. The method of claim 1, wherein the monetary amount is funded by a provider of the mobile wagering app.

4. The method of claim 1, wherein recognizing comprises processing the first data to determine whether a retail transaction event satisfies at least one criterion that renders it a qualifying transaction event.

5. The method of claim 1, wherein the jackpot terminal comprises a dedicated jackpot terminal that functions primarily to support management and distribution of jackpots to users of the mobile wagering app that are funded based on qualifying retail transaction events.

6. The method of claim 1, wherein the jackpot terminal is NFC-enabled and wherein recognizing a qualifying retail transaction event comprises receiving the first data as a result of the first user tapping an NFC-enabled user mobile device to the jackpot terminal.

7. The method of claim 1, wherein processing the jackpot awarding event comprises determining, based on a random number generator, whether the user is a primary jackpot winner.

8. The method of claim 1, wherein the recognizing of the qualifying retail transaction event triggers the jackpot awarding event.

9. The method of claim 1, wherein the recognizing of the retail transaction event is performed at a first time that is a time the first user is physically located at a retail location at which the jackpot terminal is placed.

10. The method of claim 9, wherein the processing of the jackpot awarding event is performed at a second time that is after the qualifying retail transaction event is concluded.

11. The method of claim 1, wherein the geolocation data associated with the primary jackpot winner comprises geolocation data of a mobile device corresponding to the primary jackpot user, upon the recognition of the qualifying retail transaction event.

12. The method of claim 1, wherein the geolocation data associated with the primary jackpot winner comprises geolocation data of the jackpot terminal at which the qualifying retail transaction event was recognized.

13. The method of claim 1, wherein identifying the at least one secondary jackpot winner is further based on geolocation data of a user mobile device corresponding to the at least one secondary jackpot winner.

14. A non-transitory, computer-readable medium for facilitating retail-funded jackpot functionality of a mobile wagering app, storing instructions which cause a processor to perform a method, the method comprising:
recognizing, based on first data received from jackpot terminal corresponding to a point of sale of a physical retail store, a qualifying retail transaction event involving a first user of a mobile wagering app;
contributing, based on the first data, a monetary amount to a jackpot that users of the mobile wagering app can win without placing wagers thereon;
processing a jackpot awarding event to determine that the first user is a winner of the jackpot, thereby identifying the first user as a primary jackpot winner;
distributing, via the mobile wagering app, a first portion of the jackpot to the primary jackpot winner;
identifying, based on geolocation data associated with the primary jackpot winner, at least one second user within a predetermined proximity to the primary jackpot winner, thereby identifying at least one secondary jackpot winner; and
distributing, via the mobile wagering app, a second portion of the jackpot to the at least one secondary jackpot winner.

15. The non-transitory, computer-readable medium of claim 14, wherein the first data includes a retail value corresponding to the retail transaction and wherein the monetary amount is based on the retail value.

16. The non-transitory, computer-readable medium of claim 14, wherein the monetary amount is funded by a provider of the mobile wagering app.

17. The non-transitory, computer-readable medium of claim 14, wherein recognizing comprises processing the first data to determine whether a retail transaction event satisfies at least one criterion that renders it a qualifying transaction event.

18. The non-transitory, computer-readable medium of claim 14, wherein the jackpot terminal comprises a dedicated jackpot terminal that functions primarily to support management and distribution of jackpots to users of the mobile wagering app that are funded based on qualifying retail transaction events.

19. The non-transitory, computer-readable medium of claim 14, wherein the jackpot terminal is NFC-enabled and wherein recognizing a qualifying retail transaction event comprises receiving the first data as a result of the first user tapping an NFC-enabled user mobile device to the jackpot terminal.

20. The non-transitory, computer-readable medium of claim 14, wherein processing the jackpot awarding event comprises determining, based on a random number generator, whether the user is a primary jackpot winner.

21. The non-transitory, computer-readable medium of claim 14, wherein the recognizing of the qualifying retail transaction event triggers the jackpot awarding event.

22. The non-transitory, computer-readable medium of claim 14, wherein the recognizing of the retail transaction event is performed at a first time that is a time the first user is physically located at a retail location at which the jackpot terminal is placed.

23. The non-transitory, computer-readable medium of claim 22, wherein the processing of the jackpot awarding event is performed at a second time that is after the qualifying retail transaction event is concluded.

24. The non-transitory, computer-readable medium of claim 14, wherein the geolocation data associated with the primary jackpot winner comprises geolocation data of a mobile device corresponding to the primary jackpot user, upon the recognition of the qualifying retail transaction event.

25. The non-transitory, computer-readable medium of claim 14, wherein the geolocation data associated with the primary jackpot winner comprises geolocation data of the jackpot terminal at which the qualifying retail transaction event was recognized.

26. The method of claim 14, wherein identifying the at least one secondary jackpot winner is further based on geolocation data of a user mobile device corresponding to the at least one secondary jackpot winner.
